(19) United States
(12) Patent Application Publication
(10) Pub. No.: US 2026/0274624 A1
(43) Pub. Date: Sep. 17, 2026

(54) CASSETTE SECUREMENT MECHANISM

(71) Applicant: Toyota Motor Engineering & Manufacturing North America, Inc., Plano, TX (US)

(72) Inventor: Dale C. Kitchen, Paris (CA)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/077,542

(22) Filed: Mar. 12, 2025

(51) Int. Cl. B66F 9/02

(52) U.S. Cl. CPC B66F 9/02; B66F 2700/123

(57) ABSTRACT

A cassette securement mechanism designed to prevent undesirable positional shifting of a cassette on a platform of a lifting mechanism during loading and unloading of the cassette. The securement mechanism includes a stopper assembly structured to be movable in a first direction responsive to contact with a first side of a cassette moving in the first direction. The securement mechanism also includes a catch arm operatively connected to the stopper assembly so as to rotate in a first rotational direction and into contact with a second side of the cassette opposite the first side, responsive to movement of the stopper assembly in the first direction. The securement mechanism applies forces along forward and rear sides of the cassette to immobilize the cassette when it resides on a platform of the lifting mechanism, thereby facilitating raising, lowering, loading and unloading of the cassette.

### TECHNICAL FIELD

The present invention relates to a wheeled transport cart for a manufacturing environment and, more particularly, to a mechanism for maintaining a wheeled transport cart in a predetermined position on a transport system for loading and unloading of the cart.

### BACKGROUND

A wheeled transport cart (or “cassette”) may be used to transport tooling and other items between stations in a manufacturing environment. The cassette may be moved to a particular station where it is positioned on a platform of a lifting mechanism. The lifting mechanism may then be used to raise and lower the platform to facilitate loading and unloading of the cassette. However, due to necessary clearances and tolerances, the cassette may move back and forth to some degree while it is positioned on the platform. This movement may impede raising, lowering, loading and unloading of the cassette of the cassette.

### SUMMARY

In one aspect of the embodiments described herein, a cassette securement mechanism includes a stopper assembly structured to be movable in a first direction responsive to contact with a first side of a cassette moving in the first direction. The mechanism also includes a catch arm operatively connected to the stopper assembly so as to rotate in a first rotational direction and into contact with a second side of the cassette opposite the first side, responsive to movement of the stopper assembly in the first direction.

### BRIEF DESCRIPTION OF THE DRAWINGS

FIG. 1 is a schematic perspective view of a portion of a cassette transport system incorporating a cassette securement mechanism in accordance with an embodiment described herein, and showing a cassette moving along rails of the transport system in a D1 direction toward the cassette securement mechanism.

FIG. 2 is the schematic perspective view of FIG. 1, showing the cassette moved onto a loading/unloading platform and secured on the platform by the cassette securement mechanism.

FIG. 3A is a schematic perspective view of the cassette securement mechanism if FIGS. 1-2, showing a catch arm and a stopper assembly of the cassette securement mechanism in respective dwell configurations, as shown in FIG. 1.

FIG. 3B is the schematic perspective view of the cassette securement mechanism if FIG. 3A, showing the catch arm and the stopper assembly of the cassette securement mechanism in respective cassette securement configurations.

FIG. 4 is a is a schematic perspective view of the portion of the cassette transport system of FIGS. 1-2, showing the cassette positioned on the loading/unloading platform with the platform lowered for loading/unloading the cassette and the cassette secured on the platform by the cassette securement mechanism.

FIG. 5A is a schematic side view of a portion of the cassette transport system structured to support the cassette, showing a loading/unloading platform base of the cassette transport system during lifting from a lowered position toward a raised position into which a lever rotatably mounted on a bracket coupled to the platform contacts the catch arm when the catch arm is in a cassette securement configuration. OK

FIG. 5B is a schematic perspective view of the portion of the cassette transport system shown in FIG. 5A, showing the loading/unloading platform base and a portion of the lever during lifting of the platform base from a lowered position toward the raised position.

FIG. 5C is the schematic side view of FIG. 5A, showing rotation of the loading/unloading platform base to produce a corresponding rotation of the catch arm out of contact with the cassette when the loading/unloading platform base is raised to its raised position.

FIG. 5D is a schematic perspective view of the portion of the cassette transport system shown in FIG. 5B, showing the loading/unloading platform base pressing down on an end of the lever as shown in FIG. 5C to rotate the lever into contact with the catch arm, for lifting and rotating the catch arm.

FIG. 6 is the schematic perspective view of FIG. 4, showing the cassette rolling off of the loading/unloading platform base after elevation of the loading/unloading platform base and rotation of the lever to disengage the catch arm from contact with the cassette.

### DETAILED DESCRIPTION

Embodiments described herein relate to a cassette securement mechanism designed to prevent undesirable positional shifting of a cassette on a platform of a lifting mechanism during raising, lowering, loading and unloading of the cassette. In one aspect, the cassette securement mechanism includes a stopper assembly structured to be movable in a first direction responsive to contact with a first side of a cassette moving in the first direction. The cassette securement mechanism also includes a catch arm operatively connected to the stopper assembly so as to rotate in a first rotational direction and into contact with a second side of the cassette opposite the first side, responsive to movement of the stopper assembly in the first direction. The cassette securement mechanism applies forces along forward and rear sides of the cassette to immobilize the cassette when it resides on a platform of the lifting mechanism, thereby facilitating raising, lowering, loading and unloading of the cassette.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Unless otherwise noted, similar reference characters are used to describe similar features on separate elements and/or embodiments.

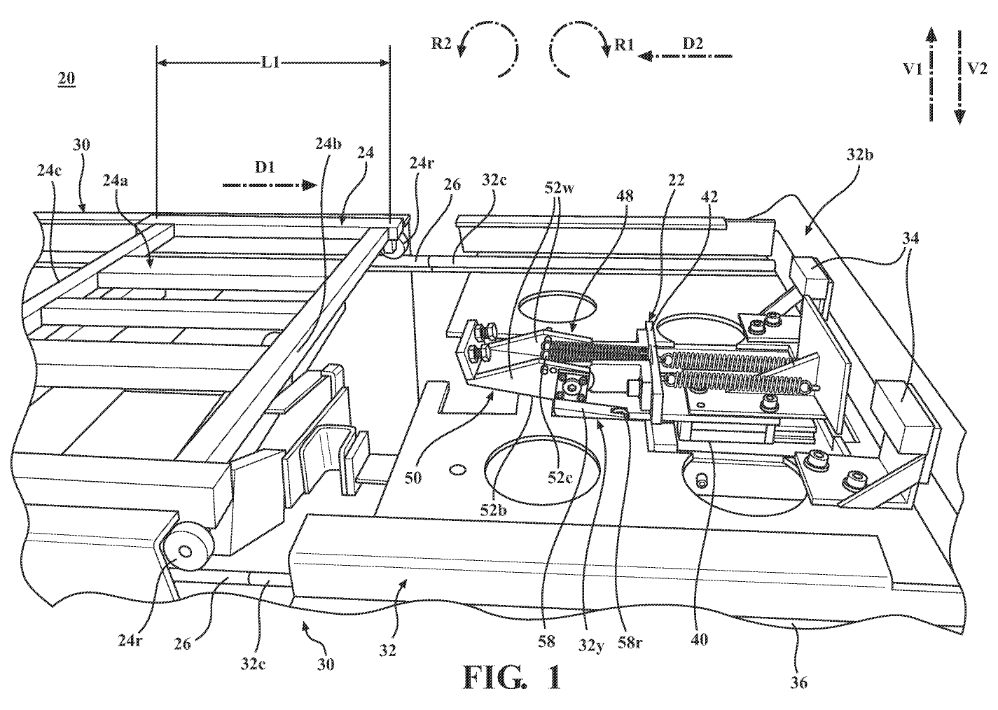

FIG. 1 is a schematic perspective view of a cassette transport system 20 incorporating a cassette securement mechanism (generally designated 22) in accordance with an embodiment described herein. Generally, a “cassette securement mechanism” is a mechanism structured to fix a cassette in a specified position while the cassette is being loaded and/or unloaded.

For purposes described herein, a “cassette” may be defined as a wheeled or sliding platform structured to move along a set of parallel tracks or rails 26 incorporated into a frame 30 of the cassette transport system 20. The tracks or rails 26 may extend between two or more locations in a manufacturing or assembly environment (for example, between a parts storage area and a line assembly station). The cassette 24 may support items (e.g., component parts, assembly tools, etc.) for transport between locations along the rails. FIG. 1 shows a cassette 24 including a cassette platform 24a and a plurality of wheels or rollers 24r rotatably mounted to the platform 24a along opposite sides of the platform to enable rolling of the cassette 24 along the transport system frame rails 26.

The cassette 24 may have a first side 24b facing in a direction D1 (toward a loading/unloading platform 32 of the cassette transport system 20) when the cassette 24 is positioned on the frame rails 26, and a second side 24c positioned opposite the first side 24b and facing toward a direction D2 opposite direction D1 and away from the loading/unloading platform 32. In the exemplary arrangement shown in FIG. 1, the cassette transport system 20 is structured so that the cassette 24 may move along frame rails 26 in a direction D1 toward the loading/unloading platform 32 and also in a direction D2 away from the loading/unloading platform 32).

Referring to FIG. 1, in one or more arrangements, the cassette transport system 20 may include a frame 30 incorporating the rails 26. The rails 26 may be structured to support the cassette 24 so as to enable motion of the cassette between separate locations along the transport system. In some arrangements, the rails 26 may be mounted in parallel along portions of the frame 30.

Generally, the cassette transport system 20 and the cassette 24 may be structured to facilitate movement, loading and unloading of the cassette 24. In one or more arrangements, the cassette transport system 20 includes a loading/unloading platform 32 positioned along the rails 26 at locations where cassette loading and/or unloading is to take place. In one or more arrangements, the loading/unloading platform 32 may be structured to move vertically upwardly (in a direction V1) and downwardly (in a direction V2) to facilitate loading and unloading of the cassette.

The loading/unloading platform 32 may include a loading/unloading base 32b with rail sections 32c separate from the frame rails 26 but alignable with the frame rails so that a cassette 24 moving along the frame rails 26 can roll smoothly onto (and off of) the loading/unloading platform rail sections 32c. The loading/unloading platform 32 may include one or more cassette hard stops 34 extending upwardly from an edge of the platform 32, to halt and define a limit of motion of the cassette 24 on the platform 32.

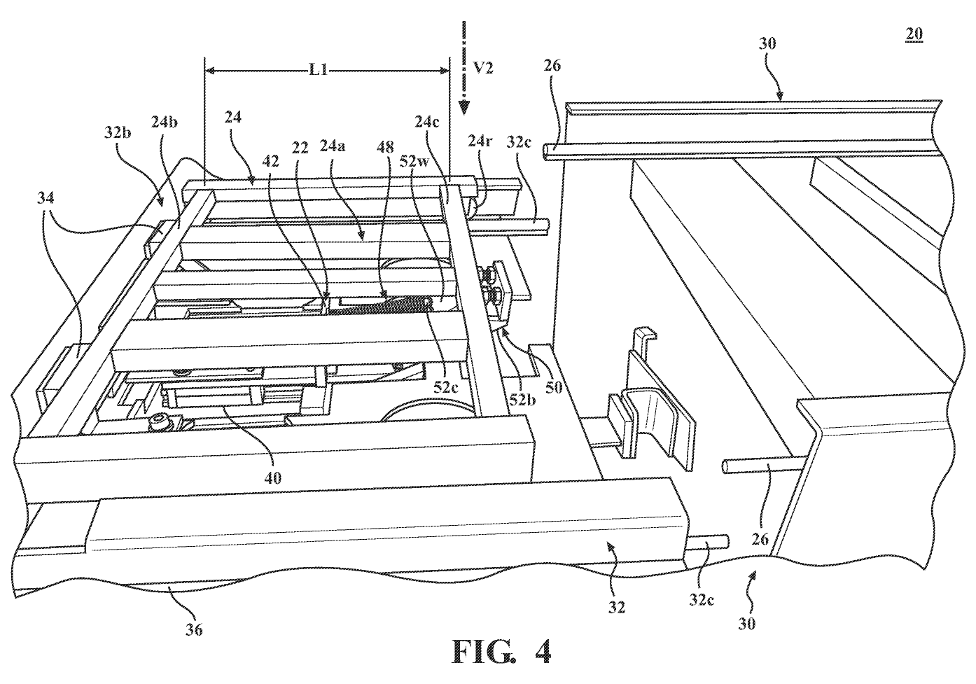

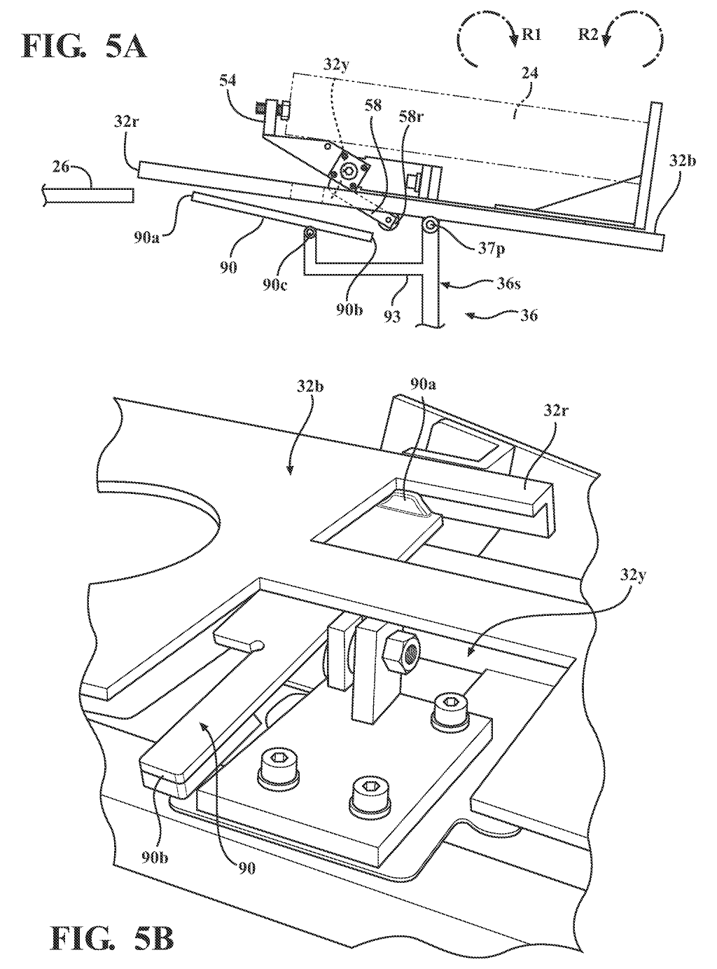

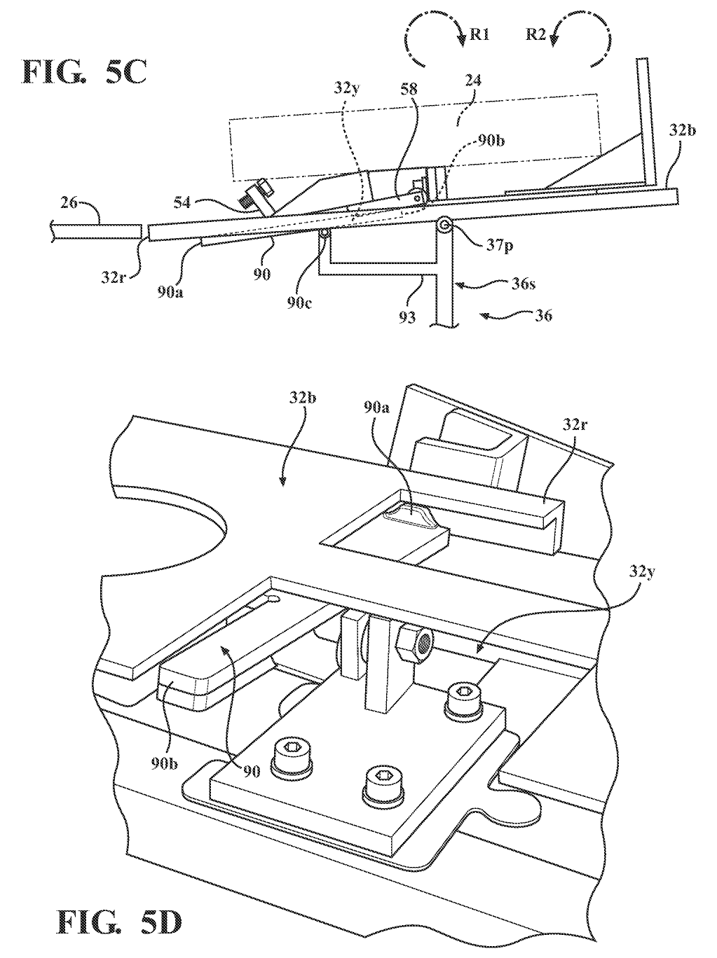

The loading/unloading platform 32 may be movably supported on a lifting mechanism (generally designated 36) structured to raise and lower the platform 32 manually and/or automatically responsive to the occurrence of one or more desired trigger events. The lifting mechanism 36 may incorporate shafts (such as shaft 36s, FIGS. 5A-5C), motors, gears, hydraulic or pneumatic cylinders, or any other suitable mechanism(s) (not shown). The lifting mechanism 36 may be structured to move the loading/unloading platform 32 between the raised position (shown in FIGS. 1, 2, and 5D) and a lowered position (shown in FIG. 4). Referring to FIG. 1, the loading/unloading base 32b may be rotatably connected to a portion of the lifting mechanism 36 by a pivot 37p. FIGS. 5A-5C show the loading/unloading base 32b rotatably mounted on a shaft 36s of the lifting mechanism 36 structured to move in opposite vertical directions V1 and V2 responsive to control signals.

The “raised position” of the loading/unloading base 32b may be a position of the loading/unloading base 32b in which the shaft 36s or other portion of the lifting mechanism 36 supporting the loading/unloading base 32b is at its maximum extension or vertical height above a ground surface or other surface on which the cassette transport system 20 resides. This position may provide the greatest overall vertical height of the loading/unloading base 32b. In addition, the location of pivot 37p and the structure of the loading/unloading base 32b may be specified so that the loading/unloading base 32b is rotationally biased in the direction R2 with respect to the pivot 37p when the base 32b is in the raised position (i.e., so that the loading/unloading base 32b tilts downwardly (toward direction V2) proceeding from the pivot 37p in direction D2 when the base 32b is in the raised position) and no cassette 24 is supported on the base 32b, as shown in FIG. 1. Also, in the raised position and with no cassette 24 supported on the base 32b as shown in FIG. 1, the rail sections 32c of the loading/unloading platform 32 are aligned with the frame rails 26 so that a cassette 24 moving along the frame rails 26 can roll smoothly onto (and off of) the loading/unloading platform rail sections 32c.

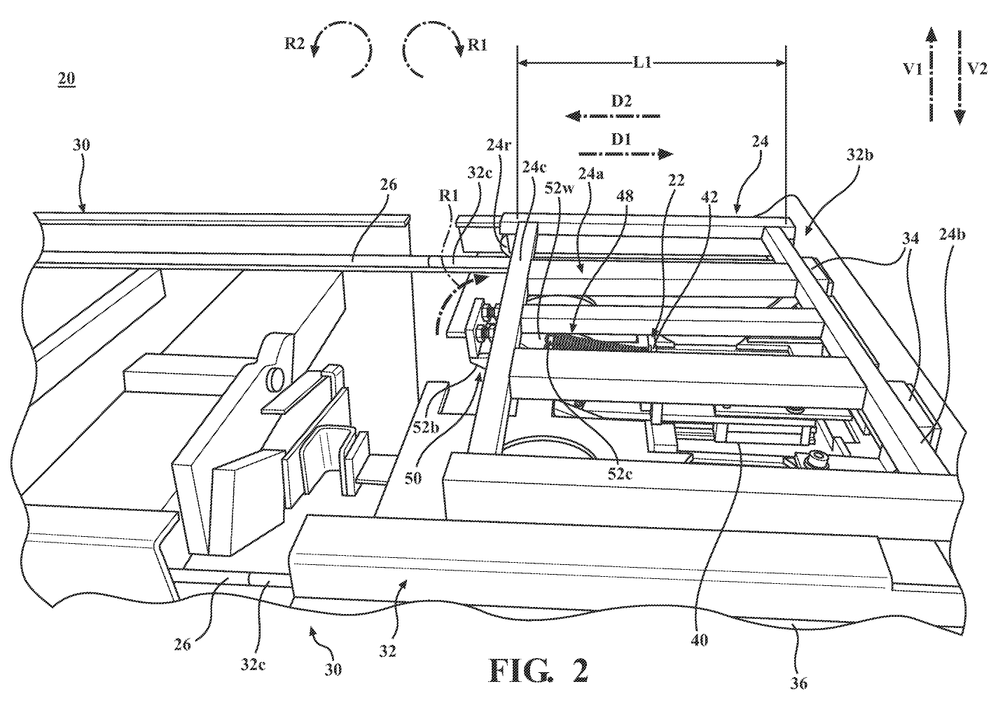

referring to FIG. 2, the location of pivot 37p and the structure of the loading/unloading base 32b may also be specified so that movement of a cassette 24 in direction D1 onto the base 32b causes the base to rotate about the pivot 37p in direction R1 so that the rail sections 32c of the loading/unloading platform 32 are no longer aligned with the frame rails 26. Thus, the base 32b may be rotationally biased in the direction R1 when the base 32b is supporting a cassette thereon and is in the raised position (i.e., so that the loading/unloading base 32b tilts downwardly (in direction V2) proceeding from the pivot 37P in direction D1 when the base 32b is in the raised position, with a cassette supported on the base 32b).

Also, the location of pivot 37p and the structure of the loading/unloading base 32b may be specified so that the loading/unloading base 32b is rotationally biased in the direction R1 when the base 32b is supporting a cassette thereon and is not in the raised position (i.e., so that the loading/unloading base 32b tilts downwardly (in direction V2) proceeding from the pivot in direction D1 when the base 32b is not in the raised position, such as when the base 32b is in the process of being lowered or raised with a cassette supported on the base 32b). This may help prevent the cassette 24 from moving in direction D2 during loading and unloading.

Referring to FIG. 1, the loading/unloading base 32b may include an opening 32y structured to enable portions of a catch arm roller support 58 and an associated roller 58r (described in greater detail below) to extend below the base 32b when the catch arm 50 is rotated to a cassette securement configuration as described herein. The opening 32y also enables an end 90b of a lever 90 (described in greater detail below) to contact roller 58 mounted on roller support 58, to rotate the catch arm in direction R2 as described herein.

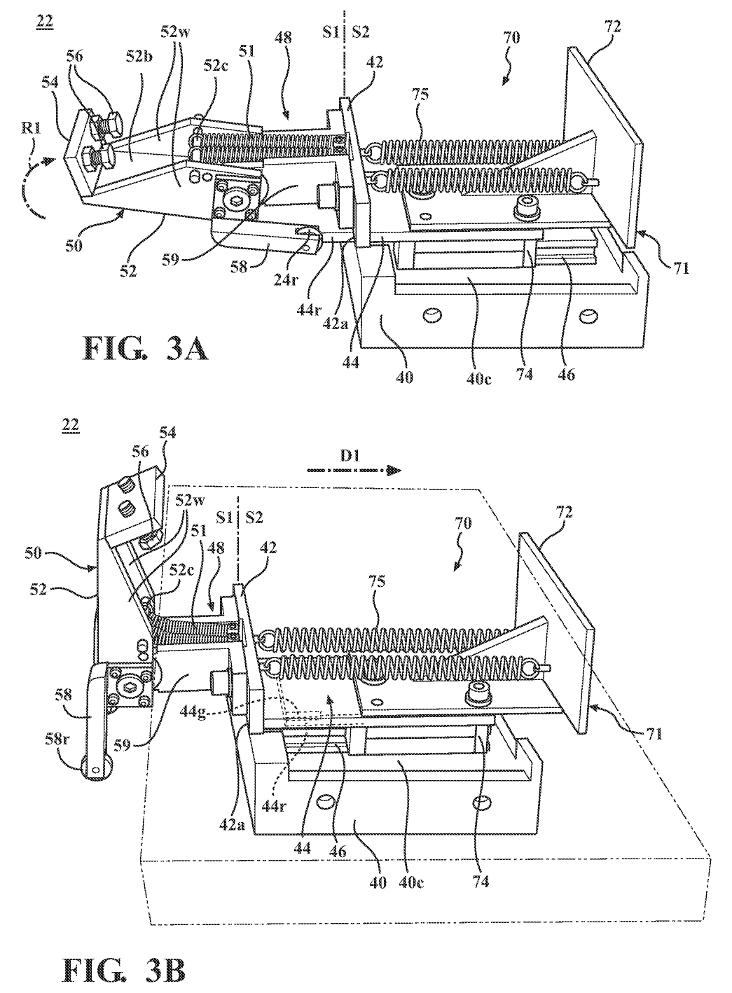

Referring to the drawings (and in particular to FIGS. 3A-3B), in one or more arrangements, the cassette securement mechanism 22 may be secured to the loading/unloading platform 32 so that the cassette securement mechanism 22 can be raised and lowered with the platform 32. The cassette securement mechanism 22 may include a base portion 40 structured to be attachable to the loading/unloading platform 32. The base portion 40 may support portions of the cassette securement mechanism 22 that move relative to the base portion 40 during operation of the cassette securement mechanism 22.

The base portion 40 may include a mounting wall 42 structured to extend generally upwardly when the cassette securement mechanism 22 is fixedly attached to the loading/unloading platform 32. The mounting wall 42 is stationary or fixed with respect to the base portion 40. The mounting wall 42 may include an opening 42a structured to enable a sliding member 44 (described below) to extend therethrough and move in directions D1 and D2 with respect to the base portion 40. In some arrangements, the base portion 40 may include a cavity 40c in which a slide or rail 46 is positioned to facilitate linear movement of the sliding member 44.

A catch assembly (generally designated 48) may be mounted on the cassette securement mechanism base portion 40 along a first side S1 of mounting wall 42. The catch assembly 48 may include a catch arm 50 operatively connected to the base portion 40. As used herein, “operatively connected” includes both direct connections (i.e., involving direct physical contact) and indirect connections (e.g., connection of one element to another via an intermediate part). In some arrangements, the catch arm 50 may have a body 52 including a base 52b and a pair of opposed side walls 52w extending from the base 52b. A connecting member 52c may extend between the opposed side walls 52w.

Catch arm 50 may include a cassette engagement flange 54 extending from the base 52b at an angle with respect to the base. The catch arm 50 may also include one or more projections 56 extending from the engagement flange 54. In one or more arrangements, the projection(s) 56 may be in the form of bolts extending through respective holes formed in the engagement flange 54. The projections 56 may be rotated or otherwise adjusted so as to extend a relatively lesser distance or a relatively greater distance from the engagement flange 54 depending on a length dimension L1 (FIG. 1) of the cassette 24, to ensure contact of the catch arm 50 with the cassette 24 when the catch arm 50 is activated to a cassette securement configuration (as shown in FIGS. 2 and 3B and described in greater detail below).

The catch arm 50 may include at least one roller support 58 extending from the catch arm body 52. The roller support(s) 58 may be formed integrally with the catch arm body 52 and/or side walls 52w, or the roller support(s) 58 may be formed separately from the catch arm body 52 and attached to an associated side wall 52w of the catch arm 50. In some arrangements, a pair of roller supports 58 extends along opposite sides of the catch arm body 52. Each roller support 58 may be attached to an associated side wall 52w of the catch arm 50 using bolts or any other suitable attachment method. Each roller support 58 of the catch arm 50 may rotatably support an associated roller 58r structured to rollingly contact a portion of an associated sliding member 44 of a slider assembly, as described in greater detail below.

In one or more arrangements, the catch arm 50 may be rotatably connected to the securement mechanism base portion mounting wall 42 via at least one mounting bracket 59 attached to the base portion mounting wall. In the embodiment shown in the drawings, the catch arm 50 is rotatably connected to the mounting wall 42 via a pair of opposed mounting brackets 59 attached to the mounting wall 42 (i.e., the catch arm 50 is mounted so as to be rotatable with respect to the mounting brackets 59 and the mounting wall 42). The rotatable connection between the mounting bracket(s) 59 and the catch arm 50 may be effected using a suitable shaft, bearing, screw or other attachment mechanism.

Depending on a length dimension L1 of the cassette 24, dimensions of the cassette securement mechanism base portion 40, the mounting brackets 59 and/or the catch arm body 52 may be specified so as to ensure that the catch arm 50 will rotate in a first rotational direction R1 when the cassette securement mechanism 22 is activated, so as to contact the cassette second side 24c (as shown in FIG. 2) after the catch arm 50 is released as described herein during movement of the stopper bracket 72 in direction D1.

Referring again to FIGS. 3A-3B, the catch assembly 48 may also include at least one spring member 51 connected to and extending between the securement mechanism base portion mounting wall 42 and the catch arm connecting member 52c. Spring member(s) 51 may be structured so as to always exert a force on the catch arm 50 urging rotation of the catch arm in first rotational direction R1. The embodiment of the catch assembly shown has two spring members 51 extending between the securement mechanism base portion mounting wall 42 and the catch arm connecting member 52c. Spring characteristics of spring member(s) 51 may be specified so that the catch arm 50 rotated by the spring members 51 exerts a desired contact or engagement force on a cassette in contact with the catch arm 50 when the catch arm is in a cassette securement configuration, to help ensure that the catch arm 50 maintains the cassette 24 in a loading/unloading position on the loading/unloading platform 32.

Referring to the drawings (and in particular to FIGS. 3A-3B), in one or more arrangements, the cassette securement mechanism 22 may also include a stopper mechanism (generally designated 70) structured to be contacted by the cassette 24 when the cassette moves onto the loading/unloading platform 32, and to gradually slow the motion of the cassette 24 after contact. In one or more arrangements, the stopper mechanism 70 may include a stopper assembly 71 translatably connected to the cassette securement mechanism base portion 40 (i.e., connected so as to enable motion of the stopper assembly along a straight line with respect to the cassette securement mechanism base portion 40, in both of directions D1 and D2). The stopper assembly 71 may include a stopper bracket 72 structured to be contacted by the cassette 24 during movement of the cassette in direction D1 onto the loading/unloading platform 32.

The stopper bracket 72 may be fixedly attached to sliding member 44. Sliding member 44 may be mounted on the rail 46 positioned in cassette securement mechanism base portion cavity 40c so as to be movable along the rail 46. In one or more arrangements, the sliding member 44 is movably mounted on the rail 46 using a linear bearing 74 attached to an underside of the sliding member 44. The bearing 74 may be structured to rollingly or slidingly contact the rail 46 so as to facilitate motion of the sliding member 44 in opposite directions D1 and D2 with respect to the cassette securement mechanism base portion 40 during operation of the cassette securement mechanism 22, while simultaneously securing the sliding member 44 to the rail 46. Alternative connection mechanisms may also be used.

The sliding member 44 may include a roller bearing portion 44r structured to support a respective one of catch arm rollers 58r when the catch arm 50 is in a dwell configuration (as shown in FIG. 3A and as described in greater detail below). In arrangements including a pair of roller supports 58 and rollers 58r extending from the catch arm body 52, the sliding member 44 may include a roller bearing portion 44r positioned along each side of opposite sides of the sliding member 44 to support an associated one of the catch arm rollers 58r. In some arrangements, a groove 44g may be formed along the roller bearing portion 44r to facilitate rolling motion of a respective catch arm roller 58r therealong.

In one or more arrangements, the stopper mechanism 70 may include at least one spring member 75 connecting the stopper bracket 72 to the cassette securement mechanism base portion 40. Spring characteristics of spring member(s) 75 may be specified so that the spring member(s) dissipate energy of motion of the cassette 24 as they stretch during movement of the stopper bracket 72 in direction D1 after being contacted by the moving cassette 24.

Referring now to FIGS. 5A-5D, in one or more arrangements, the cassette securement mechanism may also include a lever 90 spaced apart from the shaft 36s but rotatably coupled to shaft at a lever pivot 90c so that the lever 90 travels up and down with the shaft. The lever 90 may have a first end 90a, a second end 90b, and lever pivot 90c located between the first and second ends. The lever 90 may be operatively connected to the catch arm 50 and structured to be operable to rotate the catch arm 50 in the second rotational direction R2 during movement of the loading/unloading platform 32 to the raised position as described herein. As shown in FIGS. 5A and 5C, the lever 90 may be indirectly rotatably connected to the shaft 36s by mounting the lever at its pivot 90c to a bracket 93 attached to the shaft 36s.

Referring to FIGS. 5A and 5B, the lever second end 90b may be structured to be rotatable through opening 32y into contact with a roller support 58 of the catch arm 50 when the lever is rotated in second rotational direction R2. After contact, the lever 90 may rotate the roller support 58 and the connected roller 58r in second rotational direction R2 to move the roller support and roller into a position where the roller 58r can be supported by an associated roller bearing portion 44r of the sliding member 44 after the catch arm 50 has been rotated out of contact with the cassette 24 and the stopper bracket 72 moves in direction D2 under the influence of spring members 75 as described herein. The lever is rotated in direction R2 by rotation of the base 32b in direction R2. When the base is raised to its fully elevated position (shown in FIG. 1). As the base 32b rotates in direction R2, the rear portion 32r of the base 32b contacts the lever end 90a, causing rotation of the lever 90 in direction R2.

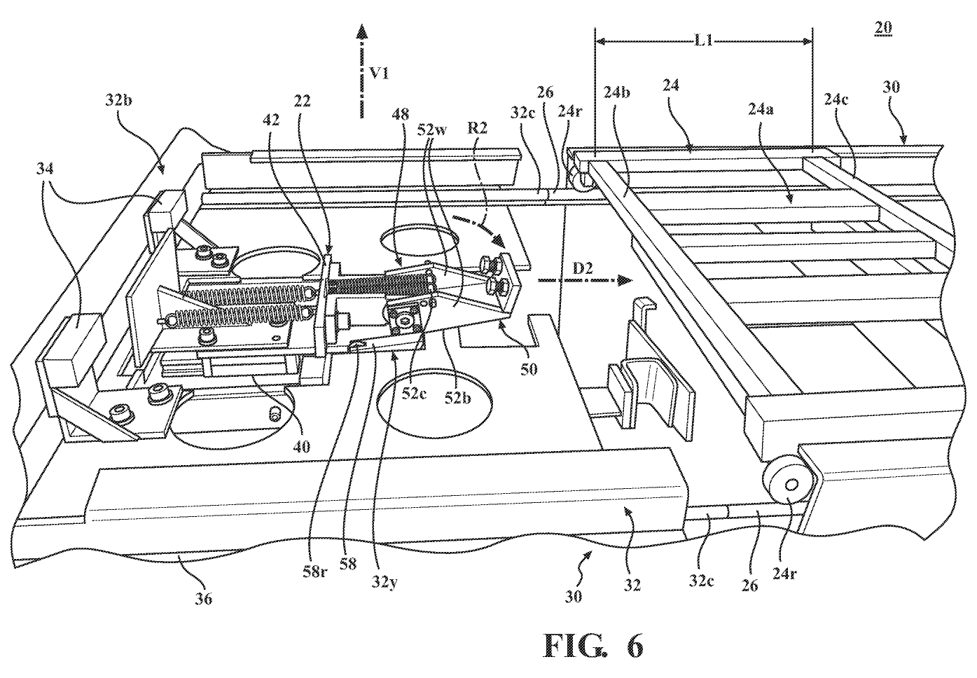

Operation of the cassette securement mechanism 22 will now be discussed with reference to FIGS. 1-4, and also with particular reference to FIGS. 5A-6.

Referring to FIG. 1, the catch arm 50 is in a catch arm dwell configuration when the catch arm roller support 58 and roller 58r are supported by an associated roller bearing portion 44r of the sliding member 44. Also, the stopper assembly 71 is in a stopper assembly dwell configuration when the stopper bracket 72 is not in contact with the cassette 24. Referring to FIG. 2, the catch arm 50 is in a catch arm cassette securement configuration when the catch arm roller support 58 and roller 58r are not supported by a roller bearing portion 44r of the stopper mechanism sliding member 44, thereby enabling the catch arm 50 to rotate in direction R1 into contact with the cassette 24. Also, the stopper assembly 71 is in a stopper assembly cassette securement configuration when the stopper bracket 72 is in contact with a cassette 24.

FIG. 1 shows the cassette 24 moving along the frame rails 26 in direction D1 toward the loading/unloading 32 platform, with the loading/unloading platform 32 in the raised position and the cassette securement mechanism 22 mounted on the loading/unloading platform 32. Platform base 32b is biased in rotational direction R2. Also, sliding member roller bearing portion(s) 44r supports roller(s) 58r, preventing rotation of the catch arm 50 in direction R1. Also, lever end 90b is in contact with roller support 58, preventing rotation of the catch arm 50 in direction R1.

Referring to FIG. 2 and 5A, the cassette rolls onto the loading/unloading platform 32 and over the cassette securement mechanism 22. This produces rotation of the base 32b in direction R1. This rotation allows the lever end 90b to rotate in direction R1 and out of contact with the roller support 58, thereby allowing subsequent rotation of the catch arm in direction R1.

Referring to FIGS. 3A, 3B and 5A, the stopper assembly 71 is structured to be movable in first direction D1 responsive to contact with a first side 24b of a cassette 24 moving in the first direction. During motion of the cassette 24 over the cassette securement mechanism 22, the cassette first side contacts 24b spring –loaded stopper bracket 72. Cassette momentum forces the stopper bracket 72 and the attached sliding member in direction D1, thereby stretching springs 75 and slowing motion of the cassette 24. Stretching of the springs 75 helps absorb energy of motion of the cassette 24. Also, catch arm 50 is operatively connected to the stopper assembly 71 so as to rotate in first rotational direction R1 and into contact with a second side 24c of the cassette 24 opposite the first side 24b, responsive to movement of the stopper assembly 71 in the first direction. More specifically, as the stopper bracket 72 moves in direction D1, catch arm roller(s) 58r roll along their respective sliding member roller bearing portion(s) 44r until ends of the roller bearing portion(s) 44r separate from the roller(s) 58r. At this point, forces exerted by catch arm spring member(s) 51 force the catch arm 50 to rotate in first rotational direction R1, wherein the catch arm 50 contacts the second side 24c of the cassette 24. With the cassette first side 24b contacted by the spring-loaded stopper bracket 72 and the cassette second side 24c contacted by the spring loaded catch arm 50, the cassette 24 is secured in the cassette securement mechanism 22 between the stopper bracket 72 and the catch arm 50 for loading/unloading.

FIG. 4 is a is a schematic perspective view of the portion of the cassette transport system of FIGS. 1-2, showing the cassette positioned on the loading/unloading platform 32 with the platform lowered for loading/unloading the cassette 24 and the cassette secured on the platform by the cassette securement mechanism. Referring to FIG. 4, after the cassette 24 is secured in the cassette securement mechanism 22, the lifting mechanism 36 may be operated to lower the loading/unloading platform 32 and the attached cassette 24 and cassette securement mechanism 22 to a position where the cassette 24 may be loaded/unloaded.

Referring to FIGS. 4 and 5A-5D, after loading/unloading of the cassette 24, the lifting mechanism 36 may be operated to raise the loading/unloading platform 32 and the attached cassette securement mechanism 22 in direction V1 to the raised position. The cassette securement mechanism 22 and the lifting mechanism 36 may be structured so that the catch arm 50 is urged in a second rotational direction R2 opposite the first rotational direction R1 against tension forces exerted by the catch arm springs 51, when the platform 32 is moved from a lowered position to the raised position. More specifically, referring to FIGS. 5C and 5D, as the loading/unloading platform 32 reaches the raised position, the platform 32 rotates in direction R2 about pivot 37p. This brings the rear portion 32r of the platform base 32b into contact with lever end 90a. This causes the lever 90 to rotate in direction R2 about lever pivot 90c, wherein lever end 90b rotates through opening 32y in loading/unloading platform 32 and into contact with roller support 58, forcing the attached catch arm 50 to rotate in direction R2 toward the dwell configuration of the cassette securement mechanism 22 and out of contact with the second side 24c of the cassette 24. When catch arm 50 is no longer in contact with the second side 24c of the cassette 24, there is no retaining force acting on the cassette second side 24c. Thus, referring to FIG. 6, the cassette 24 is free to move in direction D2 responsive to forces acting on the cassette first side 24b due to stopper bracket 72 and springs 75.

Referring to FIGS. 5C and 6, the cassette 24 is urged by stopper bracket 72 in direction D2, back off of the platform 32 and onto rails 26. As the stopper bracket 72 and the attached sliding member 44 move in direction D2, each roller bearing portion 44r of the sliding member 44 moves back into a position supporting an associated roller 24r to maintain the catch arm 50 in its respective dwell configuration. When the cassette 24 has been forced in direction D2 out of contact with the stopper bracket 72, the stopper bracket 72 is in its respective dwell configuration.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of … and ….” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A cassette securement mechanism comprising:
a stopper assembly structured to be movable in a first direction responsive to contact with a first side of a cassette moving in the first direction; and
a catch arm operatively connected to the stopper assembly so as to rotate in a first rotational direction and into contact with a second side of the cassette opposite the first side, responsive to movement of the stopper assembly in the first direction.

2. The cassette securement mechanism of claim 1, further comprising a lever operatively connected to the catch arm and structured to be operable to rotate the catch arm in a second rotational direction opposite the first rotational direction.

3. A cassette lifting mechanism comprising:
a loading/unloading platform structured to be vertically movable; and
a cassette securement mechanism in accordance with claim 2 mounted on the platform and structured so that the lever is operable to rotate the catch arm in the second rotational direction during vertical movement of the platform from a lowered position to a raised position.

4. The cassette securement mechanism of claim 1, further comprising a base portion, wherein the catch arm is rotatably connected to the base portion, wherein the stopper assembly is translatably connected to the base portion, and wherein the stopper assembly is structured to contact the catch arm when the stopper assembly is in a stopper assembly dwell configuration so as to maintain the catch arm in a catch arm dwell configuration.

5. The cassette securement mechanism of claim 4, wherein the catch arm includes at least one roller, wherein the stopper assembly includes at least one roller bearing portion structured to support the at least one roller, and wherein the at least one roller bearing portion supports the at least one roller to maintain the catch arm in the catch arm dwell configuration.

6. The cassette securement mechanism of claim 4, wherein the catch arm is structured to disengage from contact with the stopper assembly and rotate into contact with the second side of the cassette responsive to movement of the stopper assembly in the first direction.

7. A cassette transport system including a cassette securement mechanism in accordance with claim 1.

8. A cassette securement mechanism comprising:
a base portion;
a catch arm rotatably connected to the base portion; and
a stopper assembly translatably connected to the base portion connected to the base portion so as to enable translation,
the stopper assembly being structured to contact the catch arm when the stopper assembly is in a stopper assembly dwell configuration so as to maintain the catch arm in a catch arm dwell configuration, the stopper assembly being structured to disengage from contact with the catch arm responsive to translational movement of the stopper assembly in a first direction, wherein the catch arm is structured to rotate in a first rotational direction after disengagement from the stopper assembly.

9. The cassette securement mechanism of claim 8, further comprising a lever operatively connected to the catch arm and structured to be operable to rotate the catch arm in a second rotational direction opposite the first rotational direction.

10. The cassette securement mechanism of claim 8, wherein the catch arm includes at least one roller, and wherein the stopper assembly includes at least one roller bearing portion structured to support the at least one roller when the catch arm is in the catch arm dwell configuration.
